(19) United States
(12) Patent Application Publication
(10) Pub. No.: US 2020/0264795 A1
(43) Pub. Date: Aug. 20, 2020

(54) DATA DEPOSITION METHOD

(71) Applicant: AMLOGIC (SHANGHAI) CO., LTD., Shanghai (CN)

(72) Inventors: Yong QIN, Shanghai (CN); Yi ZHOU, Shanghai (CN)

(21) Appl. No.: 16/644,921

(22) PCT Filed: Sep. 6, 2018
(86) PCT No.: PCT/CN2018/104425

§ 371 Date: Mar. 5, 2020

(30) Foreign Application Priority Data
Sep. 8, 2017 (CN) 201710806859.5

(51) Int. Cl. G06F 3/06

(52) U.S. Cl. CPC G06F 3/0644; G06F 3/0653; G06F 3/0679; G06F 3/0631; G06F 3/0616; G06F 3/0652

(57) ABSTRACT

The present invention relates to a data storage technology, and in particular relates to a data depositing method applicable to a flash memory in a display device. The method comprises: step S1, dividing a first user storage area and a second user storage area from the flash memory, so as to store structured data; and step S2, circularly and alternately storing, according to one pre-set strategy, the structured data between the first user storage area and the second user storage area. According to the method, newly stored data can he found easily, and the problem of data loss caused by erasure and power outage is avoided, and the writing speed is fast and the reliability is high.

### BACKGROUND OF THE INVENTION

### 1. Field of the Invention

The invention relates to the field of data storage technology, and more particularly, to a data deposition method.

### 2. Description of the Related Art

Generally, there are two methods available for the storing of user data in the case of traditional televisions. The first method comprises the following steps: the traditional television is connected to an electrically erasable read-write memory for storing user-adjustable data such as adjustable values for items in the menu (brightness, contrast and volume, etc.) through a built-in integrated circuit bus; after adjustment, writing to the electrically erasable read-write memory through a built-in integrated circuit protocol, so as to store data successfully; and the second method is to divide a specific space in a program memory for the storage of user data, and data storage and update is achieved by changing data in the primary address for the storage of data.

A problem with the above-mentioned technology is, that a master chip needs a set of bus interfaces with built-in integrated circuits for accessing the electrically erasable read-write memory. In this case, chip hardware resources may be occupied to some extent. There is also a problem that cost will be slightly increased when an external device is connected to the platform. Reading and writing speed of the program memory is usually faster than that of an external integrated device; frequent erasure of the flash memory will have a negative impact on the security of program stored in the program, thereby shortening the life service of the flash memory. Due to the characteristics of erasure and writing of the flash memory (for the same address area, if data is updated again, the data must be erased, and the size unit, in which the data is erased, is the entire chip or a block or a sector, and there is no such a function for erasure at the byte level.

### SUMMARY OF THE INVENTION

Aiming at the above-mentioned problems in the prior art, the present invention provides a data deposition method applicable to a flash memory in a display device, the method comprising:

step S1, dividing a first user storage area and a second user storage area from the flash memory so as to store structured data; and

step S2, circularly and alternately storing, according to one pre-set strategy, the structured data between the first user storage area and the second user storage area.

In the data deposition method, wherein the pre-set strategy is to:

store the structured data in the first user storage area or the second user storage area, when any one of the first user storage area and the second user storage area is full, store the structured data in the first user storage area or the second user storage area that is not full, and the process is circularly and alternately performed;

wherein, when the first user storage area or the second user storage area, in which the storing of the structured data is currently performed, is full, all the data in the first user storage area or in the second user storage area, in which the storing of the structured data is not performed, is erased.

In the data deposition method, wherein a first single data storage area and a second single data storage area are further divided from the flash memory;

an address of the first user storage area is followed by an address of the first single data storage area; and
an address of the second user storage area is followed by an address of the second single data storage area.

In the data deposition method, wherein a storage space size of the second user storage area is equal to that of the first user storage area, and the storage space size of the first user storage area or of the second user storage area is an integer multiple of that of a sector of the flash memory

In the data deposition method, wherein a total storage space size obtained by combining the storage space size of the second user storage area and the storage space size of the second single data storage area is an integer multiple of that of the sector of the flash memory.

In the data deposition method, wherein the structured data comprises:

a data length field, and/or a data offset field, and/or a stored data field.

By adopting the above-mentioned technical solutions, the present invention has the following beneficial effects: according to the method, newly stored data can be found easily, and the problem of data loss caused by erasure and power outage is avoided, and the writing speed is fast and the reliability is high.

### BRIEF DESCRIPTION OF THE DRAWINGS

The accompanying drawings, together with the specification, illustrate exemplary embodiments of the present disclosure, and, together with the description, serve to explain the principles of the present invention.

FIG. 1 is a flow chart showing steps of a data deposition method in an embodiment according to the present invention.

### DETAILED DESCRIPTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will he thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, certain exemplary embodiments according to the present disclosure will be described with reference to the accompanying drawings.

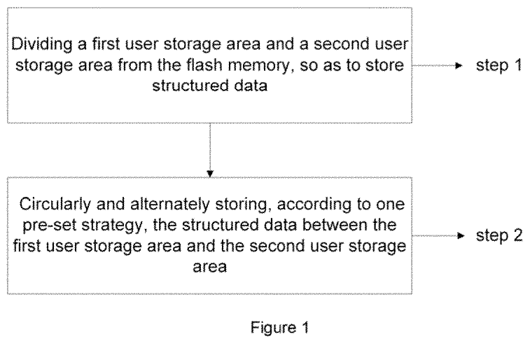

In a preferred embodiment, as shown in FIG. 1, there is provided a data deposition method applicable to a flash memory in a display device, the method comprising:

step S1, dividing a first user storage area and a second user storage area from the flash memory; so as to store structured data; and

step S2, circularly and alternately storing, according to one pre-set strategy the structured data between the first user storage area and the second user storage area.

In the above-mentioned technical solution, the use of the structured data makes it possible to easily distinguish the structured data from the single data, thus distinguishing and searching for the structured data can be achieved easily:

In a preferred embodiment, the pre-set strategy is to:

store the structured data in the first user storage area or the second user storage area, when any one of the first user storage area and the second user storage area is full, store the structured data in the first user storage area or the second user storage area that is not full, and the process is circularly and alternately performed;

wherein, when the first user storage area or the second user storage area, in which the storing of the structured data is currently performed, is full, all the data in the first user storage area or in the second user storage area, in which the storing of the structured data is not performed, is erased.

The above-mentioned embodiment is only a preferred embodiment, and other storage steps and strategies are also construed to be in the scope of the present invention, and details will not be repeated herein.

In a preferred embodiment, a first single data storage area and a second single data storage area are further divided from the flash memory;

an address of the first user storage area is followed by an address of the first single data storage area; and

an address of the second user storage area is followed by an address of the second single data storage area.

In a preferred embodiment, a storage space size of the second user storage area is equal to that of the first user storage area, and the storage space size of the first user storage area or of the second user storage area is an integer multiple of that of a sector of the flash memory.

In the above-mentioned technical solution, a storage space size of one sector is 4096 bytes.

In a preferred embodiment, a total storage space size obtained by combining the storage space size of the second user storage area and the storage space size of the second single data storage area is an integer multiple of that of the sector of the flash memory, for example, 4096 bytes or 8192 bytes, and the storage space size of one sector is 4096 bytes.

In a preferred embodiment, the structured data comprises:

a data length field, and/or a data offset field, and/or a stored data field.

In the above-mentioned technical solution, each of the structured data is the structured data of single data; for example, a value of a certain data length field may be 4, a value of a data offset field may be 0, and a value of a stored data field may be 99; the structured data may further comprise a device feature field, and/or a process feature field, and/or a format feature field, etc.

With reference to detailed description and the accompanying drawings, typical embodiments of a particular structure of the detailed description are given; while other transformation of the particular structure may be done without departing from the spirit of the present invention. Although the existing preferred embodiments are put forward in the present invention, the present invention is not limited thereto.

Variations and modifications of the present invention will be more apparent to those skilled in the art with reference to the above-mentioned detailed description. Therefore, it is intended to cover all variations and modifications within the true purpose and scope of the present invention as defined by the appended claims. Any and all the equivalents are construed to fall within the purpose and scope of the present invention.

What is claimed is:

1. A data deposition method applicable to a flash memory in a display device, the method comprising:
step S1, dividing a first user storage area and a second user storage area from the flash memory, so as to store structured data; and
step S2, circularly and alternately storing, according to one pre-set strategy; the structured data between the first user storage area and the second user storage area.

2. The data deposition method according to claim 1, wherein the pre-set strategy is to:
store the structured data in the first user storage area or the second user storage area, when any one of the first user storage area and the second user storage area is full, store the structured data in the first user storage area or the second user storage area that is not full, and the process is circularly and alternately performed;
wherein, when the first user storage area or the second user storage area, in which the storing of the structured data is currently performed, is full, all the data in the first user storage area or in the second user storage area, in which the storing of the structured data is not performed, is erased.

3. The data deposition method according to claim 1, wherein a first single data storage area and a second single data storage area are further divided from the flash memory;
an address, of the first user storage area is followed by an address of the first single data storage area; and
an address of the second user storage area is followed by an address of the second single data storage area.

4. The data deposition method according to claim 1, wherein a storage space size of the second user storage area is equal to that of the first user storage area, and the storage space size of the first user storage area or of the second user storage area is an integer multiple of that of a sector of the flash memory.

5. The data deposition method according to claim 3, wherein a total storage space size obtained by combining the storage space size of the second user storage area and the storage space size of the second single data storage area is an integer multiple of that of the sector of the flash memory.

6. The data deposition method according to claim 1, wherein the structured data comprises:
a data length field, and/or a data offset field, and/or a stored data field.
